(19) United States
(12) Patent Application Publication
(10) Pub. No.: US 2010/0250185 A1
(43) Pub. Date: Sep. 30, 2010

(54) Method for detection of gravitational anomalies

(75) Inventors: Gillian F. Marshall, Malvern (GB); Thomas J. Horton, Malvern (GB); Martin C. Butcher, Malvern (GB); Richard G. Humphreys, Malvern (GB); Stephen B. Foulkes, Fownhope (GB)

Correspondence Address: NIXON & VANDERHYE, PC, 901 NORTH GLEBE ROAD, 11TH FLOOR, ARLINGTON, VA, 22203, US

(73) Assignee: QINETIQ LIMITED, London (GB)

(21) Appl. No.: 12/659,537

(22) Filed: Mar. 11, 2010

(30) Foreign Application Priority Data
Mar. 27, 2009 (GB) 0905342.2

(51) Int. Cl. G01V 7/00

(52) U.S. Cl. 702/152

(57) ABSTRACT

A method and system for detecting gravitational anomalies comprises measuring surface structures, measuring gravitational field characteristics, and estimating the effect of the surface structures on the gravitational measurements. The estimations are then used to derive a representation of nearby non visible features such as changes in rock density, voids, or oil and gas deposits. The surface structures may be measured by a video camera, with the video sequence being processed to estimate 3D positions of structures relative to the measurement point. Other methods may be used, such as lidar or acoustic techniques as appropriate. The method may be applied above ground and also has efficacy in borehole and sewer surveying applications.

The present invention is concerned with the detection of anomalies in gravitational fields. More particularly it concerns the detection of such anomalies using equipment adapted to measure gravitational fields.

It is known to use both gravimeters, and gravity gradiometers, to measure the gravitational field due to the presence of a mass or mass variation contained in a volume, with a view to gaining an understanding of the shape and density variations of the volume. Information gained by such measurements can be used for example in general surveying, or in the petrochemical industry for analysing the spatial extent and other properties of underground materials.

A gravimeter is a device that produces an output comprising a direct measurement of the magnitude of the gravitational pull at a point. A gravity gradiometer is a device that measures the gradient of the gravitational acceleration vector. A gravity gradiometer is typically much quicker to use than a gravimeter, as it is much less susceptible to measurement errors caused by translational movement of the device caused by, for example, its location on an aircraft or ground vehicle. This is because the effects of such movements are substantially cancelled out, leaving just the gravity gradient present across the baseline.

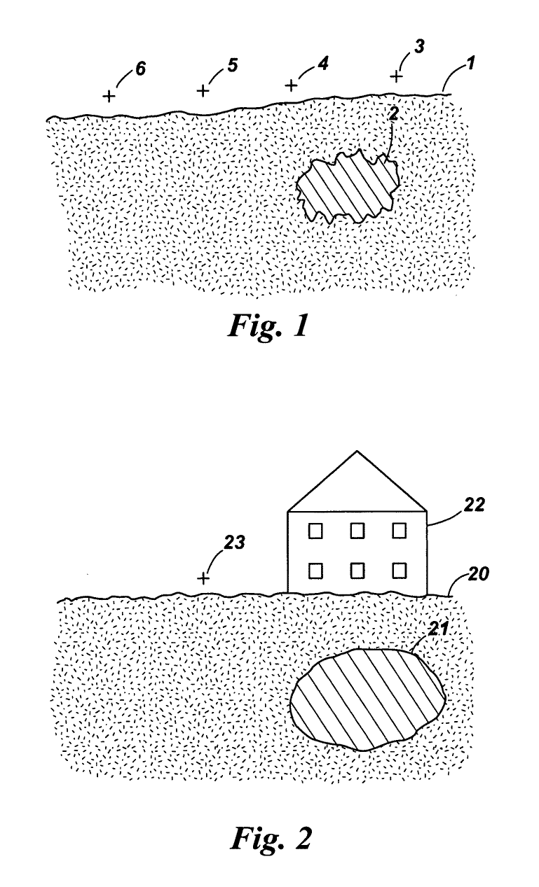

A survey using a gravity sensor of either type may be carried out in order to assess the geophysical layout of a volume of interest. FIG. 1 shows an example of how this may be employed. A profile view of a piece of ground 1 in which lies an underground feature such as a region of low density 2 is shown. A gravity sensor is used to measure the gravitational field at a series of points 3-6. A suitably sensitive sensor will provide different readings at each of the measurement points 3-6, and these readings may be processed to provide some indication as to the position and extent of the feature 2. Clearly, more measurements made will lead to more accurate results.

FIG. 1 is a very simplistic arrangement, with a relatively flat surface, and a single anomaly in the gravitational field. In practice things are rarely so straightforward. For example, large rocks, hills and buildings may be present on the surface, all of which will exert their own gravitational pull and hence add complexity into measurements taken with the gravity sensor. The presence of such items can mask the presence of underground features such as the region 2 having a different density to the region surrounding it.

Hills and valleys in the vicinity of the measured region will tend to affect the readings taken by the gravitational sensor, as they will distort the gravitational field to some degree (as compared to a flat piece of ground). It is known to compensate the gravitational measurements for the presence of any such hills and valleys when processing the gravitational measurements.

It is an object of the present invention to provide a method of producing a gravitational survey that has a generally improved accuracy over the prior art.

According to the present invention there is provided a method of producing a gravitational survey of a region comprising the steps of:
a) recording a plurality of gravitational measurements from a region in known locations;
b) obtaining information on the locations of any surface relief in the region likely to have an influence on the gravitational measurements, and calculating the mass(es) thereof;
c) using any information from step (b) to adjust the gravitational measurements to remove the effects thereon caused by the surface relief;
d) estimating a topological distribution of underground mass in the region;
characterised in that it includes the additional steps of
e) measuring a three dimensional (3D) representation of additional elements of the region likely to influence the gravitational measurements, and processing the 3D representation to estimate position and shape characteristics of the additional elements;
f) estimating a mass or masses of the additional elements of the region from the 3D representation;
g) providing the estimated mass(es) calculated in step (f) along with their position and shape information from step (e) to initialise the estimation procedure of step (d).

The surface relief features are typically those found on the earth's surface such as hills and valleys, and other such terrain, and depending upon their proximity to the gravitational measurement points will further include smaller features such as ditches etc, large mounds of earth, railway cuttings and embankments, ponds and lakes, channels through which brooks and small rivers flow etc.

The additional elements likely to influence the measurements may be man made objects such as buildings or other constructions such as bridges or even very large, heavy vehicles. They may also comprise irregularities or unevenness in the sides of boreholes or other underground conduits.

By using 3D representations of elements of the region to generate a prediction, or estimate, of the gravitational pull of those regions likely to influence the gravity sensor's readings, both in terms of terrain characteristics and additional elements such as buildings and other large constructions, and producing an estimate as to the masses of the elements, a clearer picture of the characteristics of the underground features may be obtained.

The 3D representation of the additional elements likely to influence the gravitational measurements may be an output from a video camera. Alternatively the 3D representation may comprise a series of still photographs, or a detailed plan of the relevant element or elements.

The 3D representation may also be derived from a measurement device such as a lidar system. By scanning a narrow light beam around a region, and measuring the flight time of the beam, a detailed 3D representation may be built up.

The 3D representation may also be derived from a measurement device such as a sonic or ultrasonic measurement system. Such devices are particularly suited to making measurements in liquids, where high frequency transmission is easier, and so high resolution measurement may be made.

The 3D representation may also be derived from mechanical measurement devices, such as those used to measure the sides of boreholes in the oil and gas industry. Such devices may comprise a set of arms pivoted to allow radial movement of a bearing, with having a runner or bearing on a distal end. In use the runners bear against the side of the borehole and, by monitoring the angular positions of the arms, the transverse extents of the borehole can be gauged.

The accuracy required in the 3D representation of the additional elements depends, inter alia, upon the distance of the element from the sensor. For example, measuring the positions of buildings some meters from the sensor may benefit from an accuracy in the order 20 cm, whereas for measurements in a borehole or other underground conduit, measurement accuracy of the order 1 mm may be preferred. Of course, should the measurement accuracy not be of this order, then the resulting inputs to the step of estimation of the topological arrangement will be similarly inaccurate. However, this may be acceptable for many applications, as the output is still likely to be an improvement over having no positional information on the additional elements. If using a camera to record images of the region then advantageously it is arranged to record images from positions close to those where the gravitational measurements are recorded. For example a vehicle may be equipped with one or more cameras and a gravitational sensor. For some applications it may be advantageous to record images separately from that of the recording of gravitational measurements. For example, if the gravitational measurements are being performed in a sewer pipe it may be beneficial to record the structure of buildings above ground, which clearly will require a degree of separation between the camera and gravitational sensor.

Methods of converting 2D visual information such as that obtained from a video camera into 3D information are known. For example, A. Zisserman, A. Fitzgibbon, G. Cross, VHS to VRML: 3D graphical models from video sequences, IEEE 1999 (0-7695-0253-9/99) describes a technique for generating reconstructions of 3D scenes using only 2D information. This technique does not need prior knowledge of camera position. Such information will often be available, particularly if the camera is co-located with the gravitational sensor (whose measurement positions must be known). Therefore this information can be included where available to improve the accuracy of the resulting 3D model.

The 3D representation derived from a 2D video sequence may comprise a mesh, typically a triangular mesh, generated from a point cloud representation as may be provided using the Zisserman algorithm described above.

Estimation of the masses of the additional elements identified from the 3D representation may be done in any suitable manner. One method involves a general classification of the element, e.g. a building, a brick bridge, etc, and then making an assumption of wall thickness and density. This may be done for example with reference to a look-up table. The general classification may be done manually with a person viewing the visual representation and identifying the element type. Once the element type is confirmed the system can assign a pre-stored density to the element. The general classification may instead be done using an image recognition system programmed to recognise the different types of element likely to be encountered.

Once an estimate of the masses of elements likely to influence the gravitational measurements has been obtained, along with their distances and directions from the measurement device (gravimeter or gravity gradiometer), then their influence upon the measurements may be predicted. One method of doing this is to use a known fitting algorithm. For example, a mass model may be generated, a set of synthetic gravity measurements produced based upon the mass model, an error metric that quantifies the differences between the actual gravitational measurements and the synthetic measurements produced, and the model adjusted according to a least squares optimisation procedure to minimise the error. This is known as a forward-model fitting algorithm. The procedure may be conveniently implemented using, for example, the Levenberg-Marquardt algorithm. See for example “Numerical Recipes in C”, W. H. Press et al, Cambridge University Press 1992, P683. The mass model is effectively primed with mass information from the 3D measurement and subsequent mass estimation steps. This generally results in an improved initial (i.e. pre-minimisation) mass model, which will, in general, result in a more accurate final output from the estimation procedure of step c). This mass information may comprise both of known parameters such as the situation and shape of a building, and estimated parameters, such as an assigned density of the building. Where a parameter is estimated or otherwise not known with a high degree of certainty, it may be designated as a variable parameter, allowing the forward-model fitting algorithm to adapt the parameter as it iterates.

The mass model, i.e. an estimate of topological distribution of mass (both lying underground, and above ground if significant), may be initially chosen based on prior knowledge such as that from steps b) and f) along with prior knowledge of any underground features. The underground features (and any unknown above ground features, such as density values associated with buildings measured in step e)) may be chosen as a reasonable guess as to the mass layout. Prior knowledge can assist in leading to reduced computation time of the optimisation procedure. A more complex mass model can lead to a more accurate representation of the underground layout, at the cost of increased computational effort.

A more analytic approach than the forward-model fitting algorithm described above may be used. Such analytic interpretation techniques are known, and are generally called inversion algorithms. For example, a Euler deconvolution technique similar to that used for the interpretation of magnetic data may be used. See D. T. Thompson, “EULDPH, A new technique for making computer-assisted depth estimates from magnetic data”, Geophys 47, P31-37, January 1982, (included herein by reference) which describes an analytic technique that processes magnetic data to produce depth estimates of features, but the techniques described therein are directly applicable also to gravitational sensor measurements. Such techniques may provide outputs of particular use for geological prospecting.

If gravitational field measurements are being performed in a borehole or other underground conduit, then, depending upon the depth of the gravitational sensor from the surface, the surface terrain and the additional elements may be far enough away from the sensor as to have no significance on the gravitational measurement. Such a depth may be greater than 10 m, such as greater than 20 m, such as greater than 30 m such as greater than 50 m from the surface. In this case, 3D measurements of the borehole or conduit surface may still be required, as any irregularities or unevenness in the surface may have significant effect on the measurements due to its close proximity to the sensor.

According to a further aspect of the invention there is provided a system for producing a gravitational survey, the system comprising:
a) means for recording surface structures in a region;
b) means for measuring gravitational field characteristics at a plurality of points in the region;
c) a computer comprising a processor and memory, and containing instructions enabling the computer to:
   i) receive surface structures recordings and gravitational field measurements made by the surface relief recording means and the gravitational field measurement means, and any terrain information likely to influence the gravitational field measurements; ii) calculate three dimensional positional information of elements from the surface structure measurements;
   iii) estimate a mass or masses of the surface structures;
   iv) estimate position, size and shape of sub-surface elements;
   v) calculate an improved estimate of the position, size and shape of sub-surface elements from the received gravitational field measurements and the estimated masses and any other received terrain information, using one of an inversion algorithm and a forward-model fitting algorithm.

The system may use a video camera to record the surface structures, with the structures being filmed from differing positions so as to provide multiple different view of the structures. This enables the video processing methods described herein to estimate in 3D the position, size and shape of the structures, and so also estimate their effects on any gravitational measurements taken.

The invention will now be described in more detail, by way of example, with reference to the following Figures, of which:

FIG. 1 diagrammatically illustrates a simplified scenario in which gravitational measurements may be used to detect underground features;

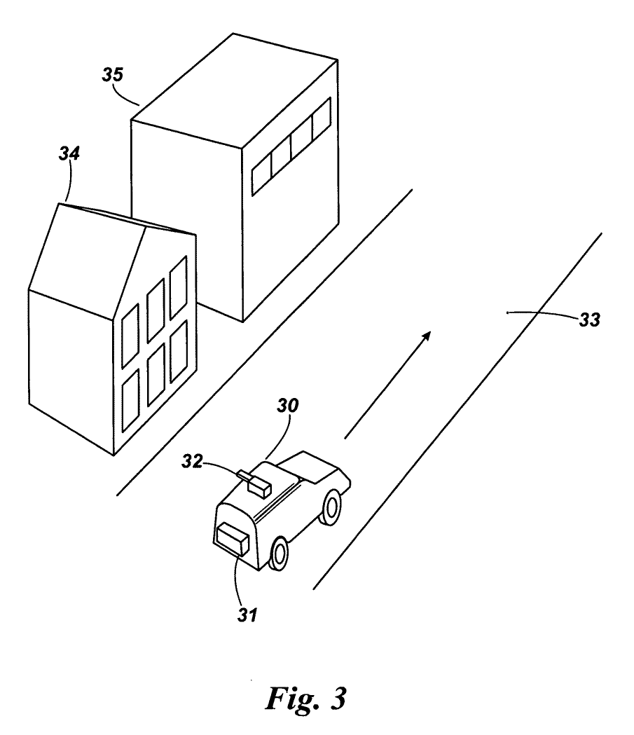

FIG. 2 diagrammatically illustrates a scenario wherein a building is situated on ground beneath which is a region of region of differing density;

FIG. 3 diagrammatically illustrates a scenario in which a first embodiment of the present invention is utilised;

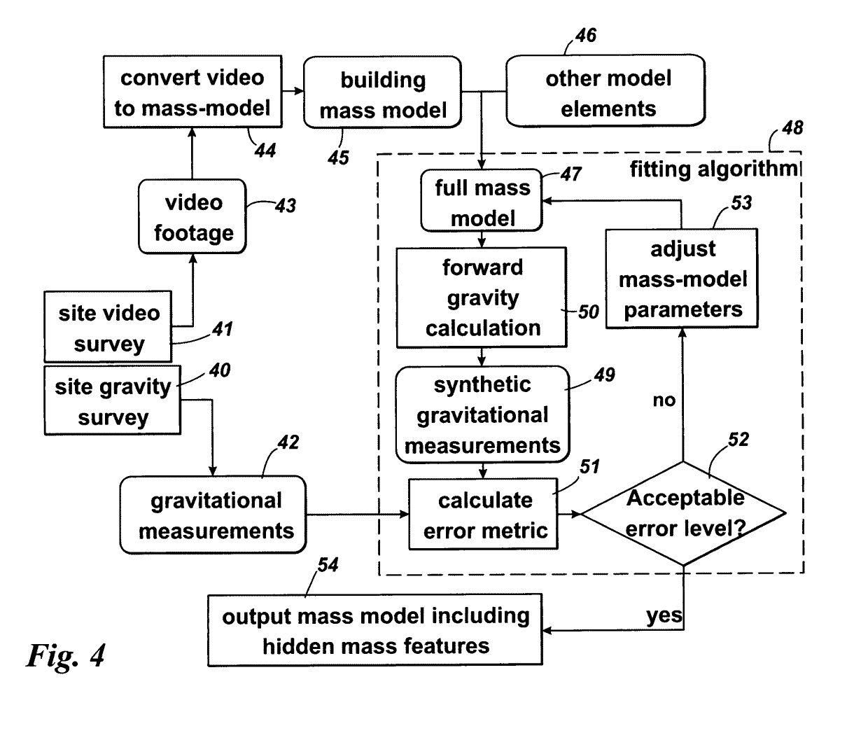

FIG. 4 shows a block diagram of a forward-model fitting process used in the first embodiment;

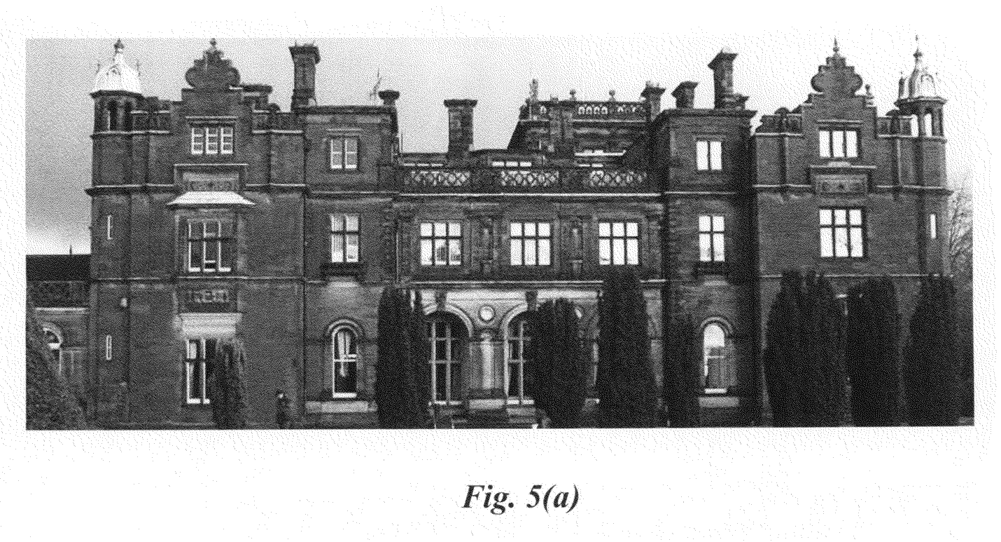

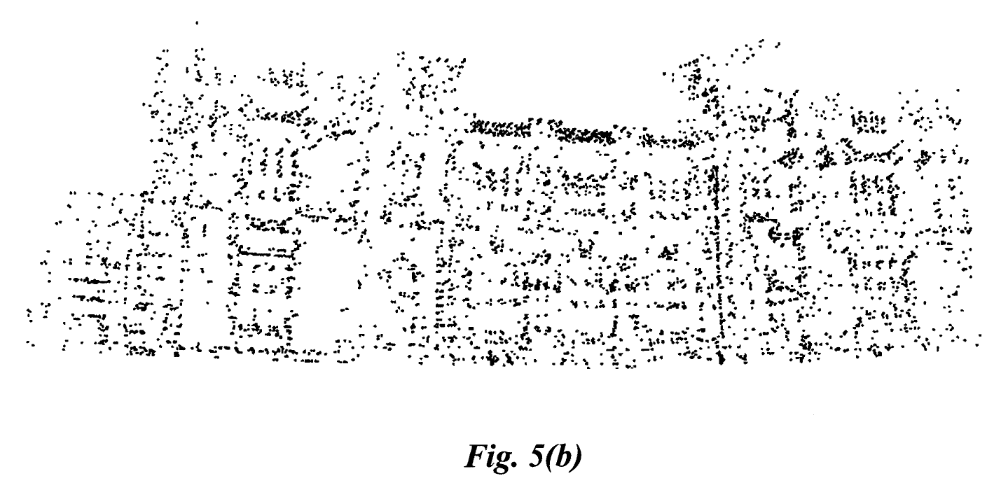

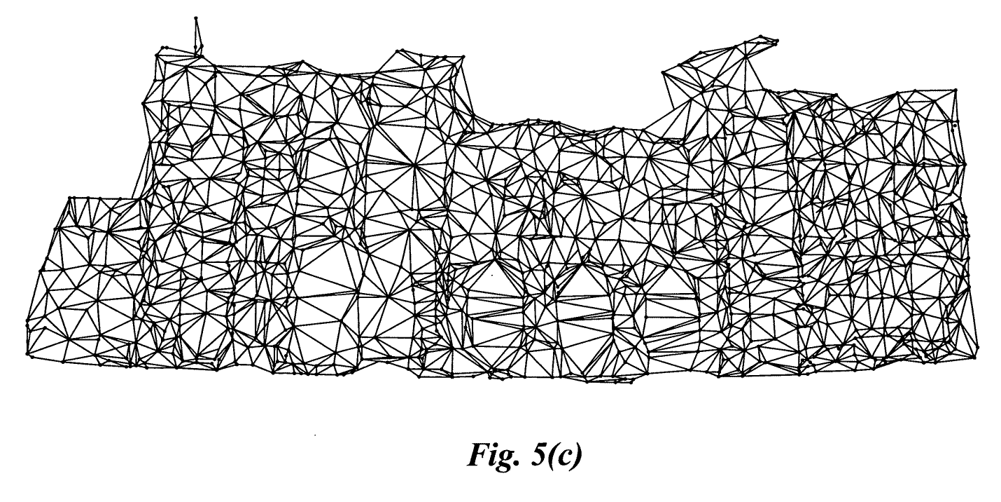

FIG. 5 shows graphically the stages used in deriving a 3D mass model of a building;

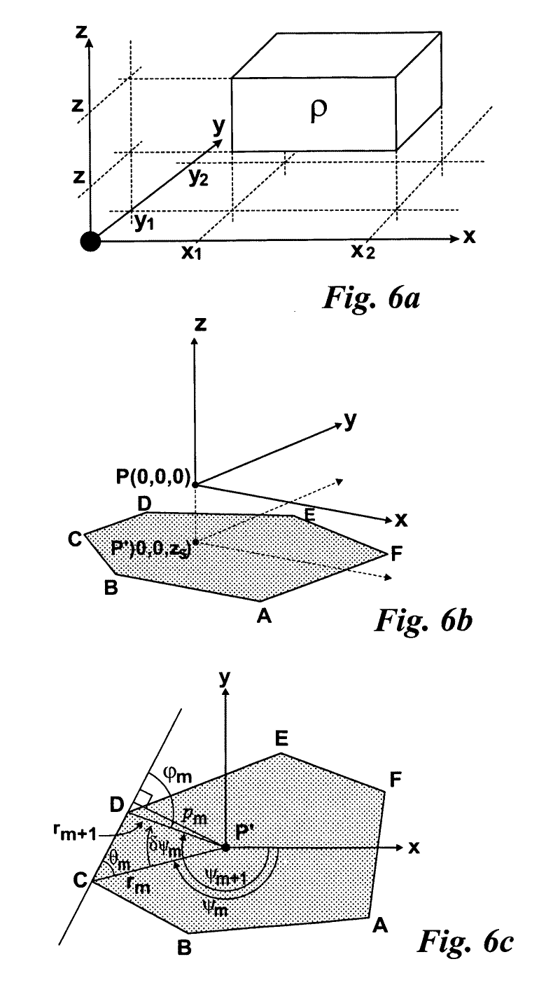

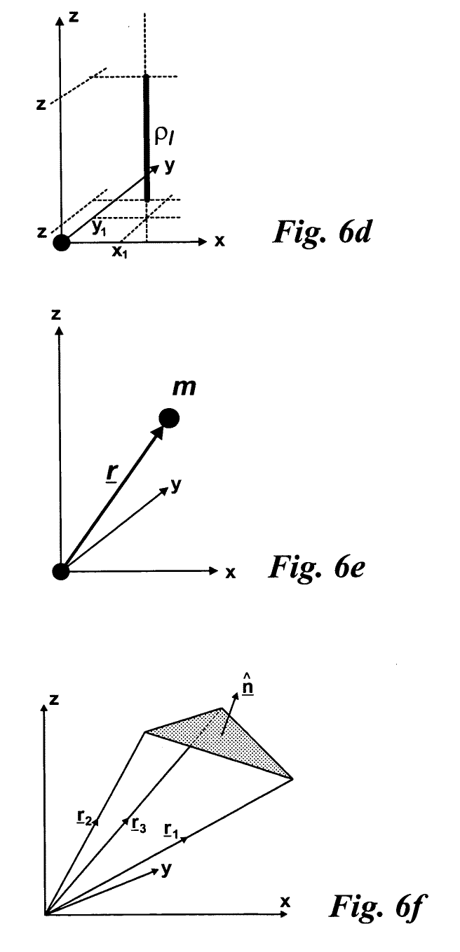

FIG. 6 diagrammatically illustrates some of the elemental masses that may be used to represent a more complex real-world mass;

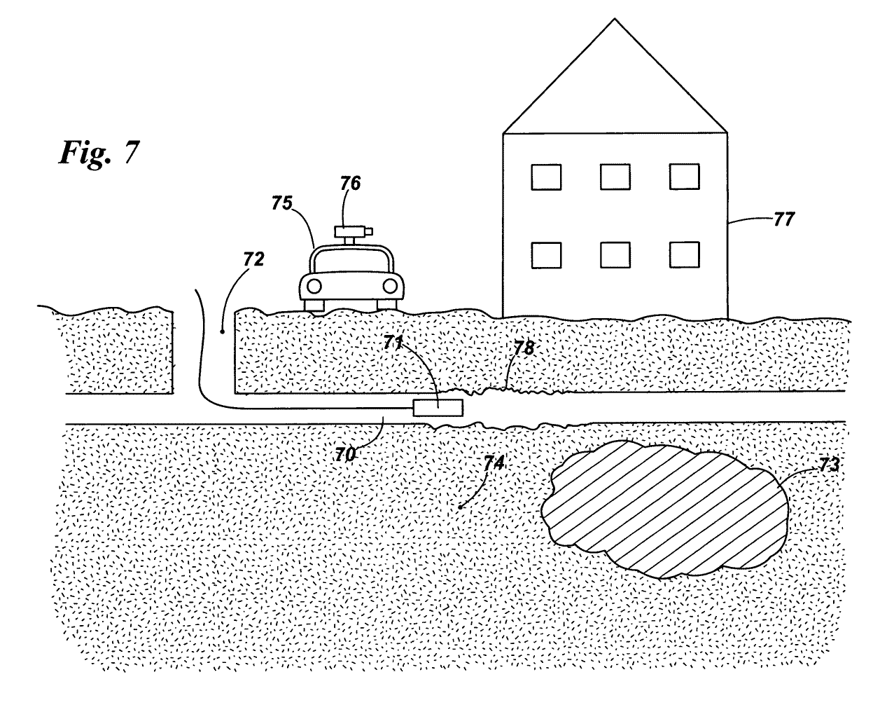

FIG. 7 shows an embodiment of the invention used in a sewer pipe; and

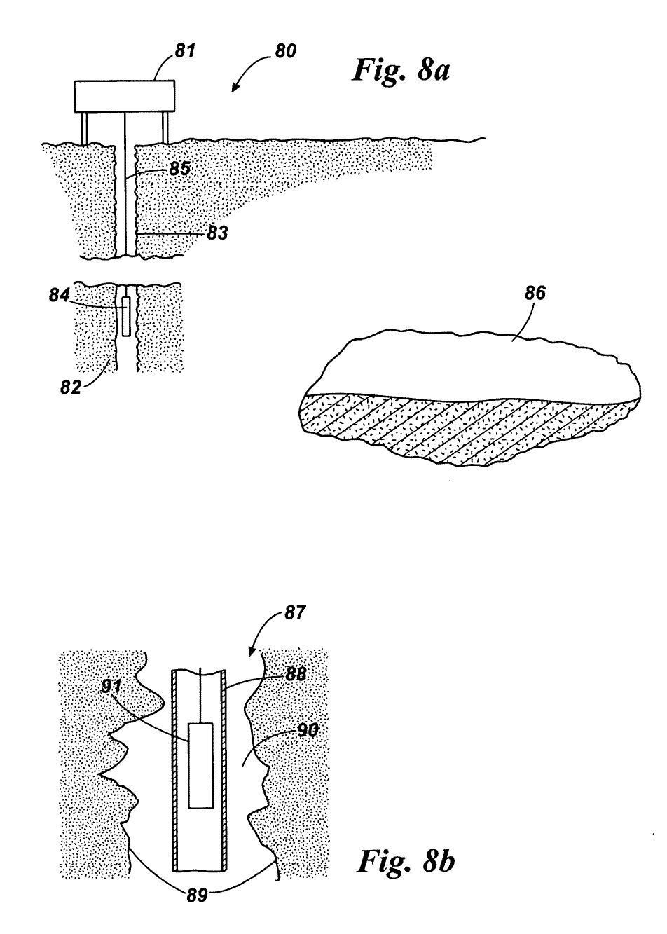

FIG. 8 shows an embodiment of the invention used in a borehole, wherein more accurate knowledge regarding features such as oil or gas may be obtained by taking into account surface roughness of the borehole or surrounding density changes.

FIG. 1 shows a cross-sectional view of a relatively flat piece of ground 1 below which lies a region of different density 2. Clearly the region 2 is not visible from the surface, but a gravimeter or gravity gradiometer of sufficient sensitivity may often be used to detect such a feature. This may be done by making a series of measurements at the surface of the force of gravity, either directly, using a gravimeter, or differentially (i.e. measuring the spatial variation of gravitational acceleration from a pair of sensors) using a gravity gradiometer.

To illustrate this, some sample measurement points are shown at 3-6. As the region 2 has a different density compared to its surrounding region (such as an underground lake or empty void), it will result in the output from a measuring instrument (assumed to have a sensitivity sufficient for this purpose) being slightly modified as compared to a measurement taken in a completely homogeneous region.

By measuring the gravity or gravity gradients e.g. at points 3-6, the collective set of measurements can be used to derive information about the underground density environment. The slight differences in the measurements made will be caused (in ideal circumstances, ignoring measurement noise) by the proximity to the region 2. The measurements may be processed in known fashion to determine the most likely location of the region, and also to estimate its volume.

There are many such algorithms that may be used to do this, but they largely fall into two types:
a) analytical inversion algorithms which calculate a position within of the region 2 and the missing (or additional) mass directly from the measurements; and
b) forward-model fitting algorithms, which compare the measurements as predicted using a model of the environment with the real measurements. The model comprises a prediction of the environment, and this model is adjusted until the predictions match observed measurements.

Either method can be used. The choice depends on the exact application, the type of computer or processing platform and the required format for the output. More complex environments than just a single, simple (e.g. spherical or rectangular) void can be characterized. They require a greater number of distinct measurements. For example, if sufficient distinct measurements are recorded, the dimensions and shape of multiple voids and other density variations can be characterised.

The underground feature or features of interest may comprise a solid of differing density to its surround, or may be a fluid reservoir such as oil, gas, water or air.

Thus it can be seen from the above description how gravitational sensors may be used to gain some knowledge of subterranean topology. The above description in relation to FIG. 1 is a known technique used in surveying.

FIG. 2 shows a slightly more complex scenario. A cross-sectional view is shown of a relatively flat piece of ground 20. The ground contains a region 21 below the surface, vertically above which is located a building 22. The region 21 has a density different to that of the region surrounding it. At measurement point 23 a gravitational sensor would, if building 22 were not present and because of the presence of the region 21, measure a slightly altered gravitational field. Region 21 is thus distorting the measurement, as described in relation to FIG. 1 above.

The presence of the building 22 (assuming the building to be above the location of the gravity sensor) will also affect the gravitational field. and so tend to distort further the gravitational field as would be measured using a gravitational sensor in a clear piece of ground with no void. This is due to the mass of the building acting upon the sensor. The exact effects would depend upon the mass and shape of the building 22 and the size, shape and density of the region 21, and the relative locations of them and the sensor measurement position 23. It can be seen however that the building 22 may act to cause further measurement errors to some degree, leading potentially to an incorrect conclusion as to the characteristics of the subterranean topology.

FIG. 3 shows operationally a first embodiment of the present invention. A vehicle 30 contains a gravity sensor 31 and a video camera 32. The vehicle 30 is arranged to travel along a road 33 lined on one side by buildings e.g. 34, 35. The vehicle 30 stops periodically, typically around every 5 meters, and records gravitational data using sensor 31. The locations of the points where measurements are taken are accurately recorded using a GPS sensor (not shown) on board the vehicle 30. Simultaneously the video camera is arranged to record images of the buildings e.g. 34, 35 along with any other significant constructions along the side of the road that may be present and visible from the vehicle 30. The video camera is directed so that it obtains views of each of the significant constructions from different viewpoints.

Once the gravitational and video data is collected, along with the GPS location data, it is processed as follows.
1. The video data is used to create a three dimensional mass model of the buildings and other constructions viewed by the video camera. This mass model comprises an estimate of the elemental masses of the buildings, along with their positions relative to the measurement point, and also their shape characteristics.
2. For each measurement point, the influence of the masses of the buildings etc. in the mass model upon the reading taken by the gravitational sensor 31 at that point are estimated.
3. The estimated gravitational data from step 2, and the gravitational data previously measured is input to an algorithm that uses the data to predict a particular form for underground features such as voids that is consistent with the measured and estimated data. Other mass data may be fed into the algorithm, such as the position, shape, and estimated mass of any natural features such as hills, trenches etc that are close enough to have a significant effect on the gravitational measurements made.

Various fitting algorithms may be used. Typically they will postulate a full mass model, and iteratively correct this model until it is consistent with the measurements made as described above.

FIG. 3 is of course a greatly simplified representation of what would typically be encountered. There would generally be buildings on both sides of the street. The computer model built up from the video will typically be a fairly complex and varying mix of building types.

As stated above, some embodiments of the present invention may employ different techniques to make a 3D measurement of elements likely to influence the gravitational sensor. Canadian company Optech Inc's ILRIS-3D system is a ground based lidar suitable for surveying buildings etc. For borehole and other conduit environments known ultrasonic borehole imagers may be used, such as that produced by Schlumberger.

FIG. 4 shows a block diagram of the process employed in an embodiment of the present invention.

The process starts with a survey of the site of interest. The survey comprises both a gravitational survey 40 and a video survey 41. The gravitational survey may comprise a series of measurements 42 taken at intervals of around 5 m using either a gravimeter or a gravity gradiometer, as explained elsewhere in this specification. The video survey may comprise of video footage 43 of significant structures in and around the site of interest. To be useful in predicting the effect of the structures on the gravitational measurements, the video footage must be analysed to estimate the masses and locations of the structures. This is done by converting 44 the video to a building mass model 45 using known techniques as described herein. Any other model elements 46, such as a priori knowledge of any underground features, or a guess as to the possible layout of any underground features, or known features such as uneven surface relief of the ground, may be added into the building mass model 45, to produce a full mass model 47. The mass model provides a relationship between the properties (size, position, shape, density etc) of the elements and the measurements. The properties of the elements are described by numerical parameters. Initial values of these parameters are set according to any a priori information that is available. This a priori information may include, but is not limited to, positions and shapes of mass elements provided by the video derived mass model.

The parameters of the mass model 47 represent a first input to a forward-model fitting algorithm, the steps of which are shown in box 48. The second input to the fitting algorithm 48 is the gravitational measurements 42 obtained from the site survey 40.

The fitting algorithm 48 works as follows:

Using the full mass model 47, a set of synthetic gravitational measurements 49, as would be measured at the same locations as the actual gravitational measurements 42 are calculated 50.
The other model elements 46 represent an initial assumption as to the structure (in terms of size, position and shape) of any underground features such as voids or other density changes present under the site. The assumptions may be of arbitrary complexity, although the more complex the assumptions made, the more processing effort will be required. Once the synthetic gravitational measurements 49 are calculated, they are compared to the actual gravitational measurements 42. An error metric is calculated 51, that records the difference between the synthetic measurements 49 and the actual measurements 42. If this difference is greater than a maximum permitted as determined at 52, then the model parameters are changed and the algorithm 48 is reiterated. Either all, or a subset of the mass model parameters are adjusted 53. However, where a particular parameter is known from measurement (such as the location of a large mass such as a bridge or building, then this parameter would generally be fixed. Furthermore, bounds may be set on the range over which a particular parameter can vary. The parameters which may vary, together with the bounds on their values, are typically set at the beginning of the process. Parameters are typically varied so as to reduce the error metric 51.

As the process is iterated more and more, and the variable other model elements 46 adjusted 53, then by analysing the adjustments made, using the fitting algorithm and their effect on the error metric (e.g. by traversing the error slope to a minima) there will generally be a reduction in the error level 51, 52. When this error has reached an acceptable level the full mass model (comprising the building information as well as information on any underground features present under the buildings) should now approximate to the actual layout of any underground features. This amended mass model 54 therefore represents the output of the whole process.

FIG. 5 shows some of the steps carried out in an embodiment of the invention in deriving the 3D mass model of the environment from a video source. Assuming the video sequence is uncalibrated, i.e. given no knowledge of the camera's optical parameters (focal length etc, but assuming the focal length does not change) or camera position with respect to the structures being recorded, the following steps are carried out:
The process starts with the data capturing step, in which a person or vehicle etc. moves around and captures a video sequence of a static scene using an uncalibrated hand-held or vehicle-mounted camera;
The recorded video sequence is then pre-processed, to e.g. remove unclear frames, removing noise and normalising for illumination changes;
The video sequence is processed to produce a 3D model of the scene and to extract the 3D camera positions
In the above process a sparse 3D point cloud of the observed object is generated, by only keeping points that are tracked for many video frames
Additional 3D points are then added to the point cloud reconstruction using a back project algorithm for points that are tracked over a smaller number of video frames
The resulting point cloud set is triangulated to generate 3D surfaces that represent the original 3D building. Of course other 3D surfaces such as rectangles could be used, to better approximate the geometry of e.g. largely rectangular buildings.

FIG. 5a shows a photograph of a building. It can be seen that the building is quite large, with an uneven frontage.

FIG. 5b shows a “point cloud” image derived from a visual video sequence of the building. Each point of the point cloud represents a feature of the building that has been tracked over a sequence of at least 20 video frames, the video being shot from a moving vehicle. Here, a feature is an element of the image that can be located in each of the at least 20 frames. As each frame is from a different viewpoint, the point cloud image contains 3D information in that the points' relative changes of position between frames can be determined.

FIG. 5c shows the conversion of the point cloud image into a triangular mesh. It can be seen that, from a macroscopic point of view, the triangle mesh appears “rougher” than the building, and this roughness will tend to add some uncertainty to the gravitational estimation step, but this uncertainty will be relatively small provided the distance from the measurement point to the building is much greater than the extent of errors in approximating the building using the triangular mesh.

Once the mesh has been generated, then a surface density can be assigned to each triangular facet. This can be done by multiplying a standard surface density (chosen according to the type of building—sandstone in this case), by an estimate of the wall thickness.

This process is carried out for each measurement point to produce a set of data comprising the gravitational field contributions of all the buildings in the vicinity of the measurement point.

Note that 3D data may comprise data obtained with any means for generating a 3D representation of the site and significant nearby masses. For many applications a video camera may be the most convenient. However, there are other means for obtaining the data. For example, a series of still photographs taken at sufficiently small intervals in space will approximate to the output of a video camera. Images taken by any means that has enough information to allow the relative positions of features of buildings etc to be calculated, and their gravitational influence estimated, will be suitable.

Lidar systems may also be used to give a 3D representation of the region of interest around the measurement points of the gravity sensor. This may be particularly suitable for example in an underground pipe, such as a sewer pipe or drain, for measuring the shape of the walls. A sonar may also be used in liquid filled holes such as sewer pipes or boreholes. 3D data may also be obtained from engineering drawings or architectural plans, for example.

Objects that form a representation of a region, such as buildings as described above, or underground gravitational features, may be represented as a set of simple components, such as the individual polygons forming the mesh in FIG. 5c. The gravitational attractions due to all components of a feature are summed in order to calculate the gravitational attraction due to the feature. Components that could be used include:
1. Volume masses—Rectangular volumes with density per unit volume; e.g. solid blocks of concrete, underground lakes or voids. More generally, the gravitational attraction of polygonal prisms can be calculated as described in D Plouff, “Gravity and Magnetic Fields of Polygonal Prisms and Application to Magnetic Terrain Corrections”, Geophysics, Vol. 41, No. 4, August 1976, 727-741.
2. Planar masses—Rectangular planes of material which are thin compared to their length and width. These masses are defined in terms of a density per unit area; e.g. walls and floors, as described above in relation to FIG. 5. This is effectively a similar case to the lamina calculation described above, but limited to rectangular form.
3. Linear masses—Masses whose widths and thicknesses are small compared to their lengths; e.g. columns, beams.
4. Point masses—compact, heavy objects with dimensions much smaller than the ranges at which the gravity anomaly will be measured; e.g. pieces of heavy machinery, tanks of liquid.

The gravitational attraction g′=(g′ₓ, g′_{y}, g′_{z})^{T} of such components may be calculated in known manner. Superscript ^{T} denotes the transpose (i.e. g′ is a column vector.

When implementing an algorithm to predict the underground features, the gravitational attraction, g=(gₓ, g_{y}, g_{z})^{T}, in the frame of reference of the individual feature components is calculated, regarding both underground and above ground features, with the observer at the origin, then the results are transformed into an observer's frame of reference to obtain g′.

FIG. 6a shows a representation of a rectangular volume mass having density ρ, length, l=x₂−x₁, width, w=y₂−y₁ and height h=z₂−z₁.

The vertical gravitational acceleration at the origin, due to the volume, is given by

$${g}_{ z} = G ρ {\sum }_{i = 1}^{ 2} {\sum }_{j = 1}^{ 2} {\sum }_{k = 1}^{ 2} {σ}_{ ijk} [ \begin{matrix}\begin{matrix}{z}_{ k} arctan \frac{ {x}_{ i} {y}_{ i}}{ {z}_{ k} {R}_{ jik}} - \\ {x}_{ i} log ( {R}_{ ijk} + {y}_{ j} ) -\end{matrix} \\ {y}_{ i} log ( {R}_{ijk} + {x}_{j} )\end{matrix} ] \\ where \\ {R}_{ijk} = \sqrt{{x}_{i}^{2} + {y}_{j}^{2} + {z}_{k}^{2}} \\ {σ}_{ijk} = {( - 1 )}^{i} {( - 1 )}^{j} {( - 1 )}^{k} \qquad ( 11 )$$

In order to calculate the other components of g, the coordinates in equation 11 are exchanged.

FIG. 6b shows a laminar mass, such as the facets described in relation to FIG. 5. The laminar mass has surface density ρₛ. The dimensions of ρₛ are mass per unit area. The gravitational field at the origin, due to a laminar mass such as that of FIG. 6c may be calculated as follows. The lamina is approximated by the polygon with M vertices at r′ₘ=(xₘ, yₘ, zₛ)^{T}.

The vertical component of g may be calculated according to M. Talwani, M. Ewing, “Rapid computation of gravitational attraction of three-dimensional bodies of arbitrary shape”, Geophysics, XXV, no. 1, February 1960, 203-225 that the vertical gravitational acceleration due to a polygonal lamina is given by

$${g}_{z} = G {ρ}_{s} {\sum }_{m = 1}^{M} [ δ {ψ}_{m} - ( arcsin \frac{z cos θ}{\sqrt{{p}_{m}^{2} + {z}^{2}}} - arcsin \frac{z cos {ϕ}_{m}}{\sqrt{{p}_{m}^{2} + {z}^{2}}} ) ] \qquad ( 1 )$$

The variables in this formula can be calculated as follows:

$$\begin{matrix}{ψ}_{m} = arctan ( \frac{- {y}_{m}}{{x}_{m}} ) & ( 3 ) \\ {δψ}_{m} = {ψ}_{m + 1} - {ψ}_{m} & ( 4 ) \\ {p}_{m} = \frac{{β}_{m}}{\sqrt{1 + {α}_{m}^{2}}} & ( 5 ) \\ {θ}_{m} = arctan [ \frac{- {β}_{m}}{{y}_{m} + \frac{{x}_{m}}{{y}_{m}} ( {x}_{m} - {β}_{m} )} ] , \\ {ϕ}_{m} = arctan [ \frac{- {β}_{m}}{{y}_{m + 1} + \frac{{x}_{m + 1}}{{y}_{m + 1}} ( {x}_{m + 1} - {β}_{m} )} ] & ( 6 a \text{,} b ) \\ {α}_{m} = \frac{{x}_{m + 1} - {x}_{m}}{{y}_{m + 1} - {y}_{m}} and {β}_{m} = \frac{{x}_{m} {y}_{m + 1} - {x}_{m + 1} {y}_{m}}{{y}_{m + 1} - {y}_{m}} , & ( 7 a \text{,} b )\end{matrix}$$

An alternative formulation for g_{z} is given in R. J. Blakely, “Potential Theory in Gravity and Magnetic Applications”, Cambridge University Press, 1996, p 187-191.

Since geophysicists are in general concerned with gravimetry surveys, they are only interested in the vertical component of gravity as described above. The horizontal component, as needed for calculating the gravity gradients, is not readily accessible in the literature. It has therefore been derived from first principles as follows.

The x component of g, for a polygonal lamina, is given by

$$\begin{matrix}{g}_{x} = - G {ρ}_{s} {\sum }_{m = 1}^{M} \frac{( {J}_{m 2} - {J}_{m 1} )}{\sqrt{1 + {α}_{m}^{2}}} \\ where & ( 8 ) \\ {J}_{m 1} = ln ( \begin{matrix}\sqrt{[ 1 + {α}_{m}^{2} ] {y}_{m}^{2} + 2 {α}_{m} {β}_{m} {y}_{m} + {β}_{m}^{2} + {z}^{2}} + \\ {y}_{m} \sqrt{1 + {α}_{m}^{2}} + \frac{{α}_{m} {β}_{m}}{\sqrt{1 + {α}_{m}^{2}}}\end{matrix} ) & ( 9 a ) \\ {J}_{m 2} = ln ( \begin{matrix}\sqrt{[ 1 + {α}_{m}^{2} ] {y}_{m + 1}^{2} + 2 {α}_{m} {β}_{m} {y}_{m + 1} + {β}_{m}^{2} + {z}^{2}} + \\ {y}_{m + 1} \sqrt{1 + {α}_{m}^{2}} + \frac{{α}_{m} {β}_{m}}{\sqrt{1 + {α}_{m}^{2}}}\end{matrix} ) & ( 9 b )\end{matrix}$$

To calculate g_{y}, change the co-ordinate system by applying the transformation

\tilde{x}ₘ=yₘ

\tilde{y}ₘ=xₘ

\tilde{z}ₘ=−zₘ (10)

and use the formula in equation (8).

FIG. 6d shows a representation of a linear mass having a mass-per-unit-length ρ₁. The vector components of gravitational acceleration at the origin, due to the linear mass, are given by:

$${g}_{x} = {x}_{1} G \frac{{ρ}_{l}}{{r}_{h}^{2}} ( sin {θ}_{2} - sin {θ}_{1} )$$

$${g}_{y} = {y}_{1} \frac{G {ρ}_{l}}{{r}_{h}^{2}} ( sin {θ}_{2} - sin {θ}_{1} )$$

$${g}_{z} = \frac{G {ρ}_{l}}{{r}_{h}} ( cos {θ}_{1} - cos {θ}_{2} )$$

$$where$$

$${r}_{h} = \sqrt{{x}_{1}^{2} + {y}_{1}^{2}}$$

$$sin {θ}_{k} = {z}_{k} / {r}_{k} \\ = \frac{{z}_{k}}{\sqrt{{x}_{1}^{2} + {y}_{1}^{2} + {z}_{k}^{2}}}$$

$$and$$

$$cos {θ}_{k} = {r}_{h} / {r}_{k} \\ = \frac{\sqrt{{x}_{1}^{2} + {y}_{1}^{2}}}{\sqrt{{x}_{1}^{2} + {y}_{1}^{2} + {z}_{k}^{2}}}$$

$$where$$

$${r}_{k} = \sqrt{{x}_{1}^{2} + {y}_{1}^{2} + {z}_{k}^{2}} .$$

FIG. 6e shows a representation of a point mass m at position r. The gravitational acceleration vector at the origin, due to the point mass, is

$$\underline{g} = \frac{Gm \underline{r}}{{r}^{3}} .$$

For each non-point-like component (volume, lamina, linear mass), the gravitational attraction, g=(gₓ, g_{y}, g_{z})^{T}, in the frame of reference of the individual feature component is calculated, with the observer at the origin, then the results are transformed into an observer's frame of reference to obtain g′.

A complex mass, such as a bridge, house, or underground feature such as a lake or underground oil or gas field may be made up from a one or more of these components, with the total gravitational attraction of the feature calculated by summing the component parts, however they may be defined.

The gravitational acceleration vector g′(r′) in the presence of a mass or mass distribution is a function of position r′. The elements of the 3×3 gravitational gradient tensor ┌ᵢⱼ(i=x, y, z; j=x, y, z) at a position r₀′ can be estimated by combining calculations of g′ at different positions. If g₀′=g′(r₀′) then

┌ᵢₓ=[g′(r₀′Δx)−g₀′]/b

┌_{iy}=[g′(r₀′+Δy)−g₀′]/b

┌_{iz}=[[g′)(r₀′+Δz)−g₀′]/b

where
Δx=bx′
Δy=by′
Δz=bz′
   and x′, y′ and z′ are unit vectors in the x′, y′ and z′ directions respectively. The constant distance b must be small with respect to the range to the nearest part of the mass or mass distribution.

Alternatively formulae for the gradient tensor elements due to each mass component could be derived by differentiating with respect to x′, y′ and z′ any formulae for g and then applying the appropriate co-ordinate transform to the resulting gradient tensor.

The mesh illustrated in FIG. 5c that is used in the present embodiment of the invention, is composed of many triangular laminae. Each of these is represented as polygonal lamina, with M=3.

FIG. 6f shows a triangular lamina defined by the positions r₁, r₂, r₃ of its vertices. In order to find the co-ordinate frame in which the lamina is parallel with the x-y plane, as in FIG. 6c, a co-ordinate transform must be applied.

The unit vector normal to the lamina is n. The sense of n can be determined as follows: An observer starts somewhere on the lamina and then moves an arbitrary distance in direction n. Looking back towards the lamina, the observer sees the vertices 1, 2, 3, appear in clockwise order.

The normal vector can be calculated at any corner of the triangle. From corner 1:

$$\underline{n} = \frac{{\underline{r}}_{13} \times {\underline{r}}_{12}}{\vert {\underline{r}}_{13} \times {\underline{r}}_{12} \vert}$$

$$where {\underline{r}}_{ij} = {\underline{r}}_{j} - {\underline{r}}_{i} .$$

To define a frame of reference where the triangular lamina is horizontal, define new axes in terms of the original ones:

x=(1/|r₁₂|)r₁₂

y=n×x

z=z′

A column vector u′ in the original frame, becomes

u=Ru′

in the transformed frame. R is a rotation matrix whose rows contain the elements of x, y, and z.

Following transformation of the vertex co-ordinates, the formulae given in equation (1) below can be used to calculate g. Then g′ in the original frame can be obtained using

g′=R^{T}g

Where R^{T} is the transpose of R.

FIG. 7 shows an embodiment of the present invention wherein the gravitational sensor is operative in an underground conduit 70, such as a sewer or water pipe, that typically resides a meter or two from the surface of the earth, and runs roughly parallel with it.

Gravitational measurements are performed in the following manner. A gravitational sensor 71 is passed through the underground conduit 70, via a shaft 72. At known points along the conduit 70 gravitational measurements are performed. This will typically be done every 2-5 metres or so, depending upon the resolution required and the expected topology of both the conduit, and any other significant features nearby the conduit.

The ground outside the conduit and shaft consists of a discrete volume of one density 73 surrounded by a uniform density medium 74. A vehicle 75 equipped with a GPS positional locator and a video camera system 76 (or a still camera adapted to take a series of successive images) travels on the ground surface recording the manmade structures, such as buildings 77, bridges etc., that are in the vicinity of the conduit. The data from the video camera is converted, using the methods described and referred to herein, into 3D surface data, i.e. including calculated positions of the buildings etc. relative to the known camera positions.

The 3D surface data is used to initialise a mass model so that it includes buildings 77. Roughness of the conduit walls 78 also constitutes gravitational clutter. Such roughness can be significant if, for example, the conduit is a crumbling sewer pipe, or a naturally occurring underground river. Where such roughness is thought to exist 3D mapping of the interior of the conduit may also be used to initialise the mass model so that it includes unevenness of the conduit walls. The 3D mapping may be done using video camera systems and subsequent processing as described above to extract the 3D information, or may be done more directly using, for example, a scanning lidar system or sonic or ultrasonic measurement methods. The sonic or ultrasonic approaches may be more suitable where the conduit contains absorbing fluids such as muddy water or oil.

The mass model, suitably initialised with information on above ground features and any surface roughness measurements is used in an inversion or forward-model fitting algorithm, to maximise sensitivity to underground density contrasts like the one between the two media (73, 74). The output of the inversion or forward-model fitting algorithms will be an approximation to the mass distribution in the vicinity of the measurement points of the gravitational sensor.

It will be understood by a person having ordinary skill in the art that the farther the conduit is underground the less effect any surface elements such as buildings etc will have on the measurements made by the gravitational sensor. The depth underground at which the surface elements may be disregarded will vary depending upon the required measurement accuracy, and the sensitivity of whatever gravitational sensor is being used. Typically, manmade surface elements such as buildings and bridges etc will have little relevance to the measurements after a few tens of meters. In these circumstances however the roughness of the conduit are likely to still be relevant to the measurement, and hence 3D mapping of the conduit surface may be used to initialise the forward fitting or inversion algorithm.

FIG. 8 shows another embodiment of the present invention, wherein the gravitational sensor is used down a borehole. The borehole may be for oil or gas exploration or recovery, for water, or for any other purpose.

Shown at FIG. 8a is a mining operation 80 comprising a well head station 81 above a borehole 82. The borehole 82 is not shown to scale. The borehole 82 has rough, irregular edges 83. A unit 84 containing a gravity sensor is shown down the borehole 82, suspended on a sonde 85 The unit 84 also contains an ultrasonic borehole profiling system, such as the Ultrasonic Borehole Imager from Schlumberger. Other profiling or borehole characterisation sensors may also be suitable, such as a radioactivity probe. A region of interest, in this case an oil well 86 comprising a large void partially filled with oil is shown some distance to the right of the borehole.

In operation the unit 84 is lowered down the borehole 82, and, in a region of interest, a sequence of gravitational field measurements are made. The gravitational sensor is first clamped against the side of the borehole so that it is stationary, and a static measurement then made. The sensor is then moved along the borehole a few metres and the process repeated. This is done until a set of measurements have been taken covering the region of interest. If prior information is available then the region of interest may comprise the whole length of the borehole. As the unit 84 is lowered the borehole profiling system measures contours of the borehole and transmits this information up the pipe 85 to a recording unit in the well head station 81. This data is used to produce a 3D contour map of the borehole sides. The gravitational information recorded by the gravitational sensor is also transmitted up the pipe 85 and recorded.

The information comprising the gravitational sensor data and the 3D profile of the borehole sides are then processed. The 3D profile data is processed to estimate the relative masses of the different parts of the sides, and their distance to the gravitational measurement sensor at the time it took each reading. This information is used to initialise a mass model, as described in relation to FIG. 4 above (but substituting the “building mass model” step 45 with a “borehole wall profile mass model” step. Additional, variable, model elements are added to the mass model, these representing a first guess of the region of interest. A fitting algorithm as described in relation to FIG. 4 may be used to amend characteristics such as position and density of these variable model elements until an error metric is within an acceptable level. An output of the model will then comprise a representation of the region of interest 86.

It is worth noting that, although the borehole walls may be relatively smooth, as they are so close to the gravitational sensor in unit 84 any surface roughness or irregularity may have a significant impact upon measurements made by the gravitational sensor in unit 84. It is preferable therefore to get an accurate representation of the borehole wall as possible, bearing in mind the required accuracy of the fitting algorithm output and the relative costs in performing the measurements.

FIG. 8b shows a section of a borehole 87 wherein the borehole 87 is lined with a steel lining pipe 88. A gravity sensor 91 is in the lining pipe 88 and is used for taking gravity measurements as described in relation to FIG. 8a. The borehole 87 has rough walls 89, and there is a variable gap 90 between the steel pipe 88 and the wall 89, this gap often being filled with mud or rock slurry. In this case the presence of the pipe 88 will make it very difficult to get accurate measurements of the wall profile 89. In such circumstances it is beneficial if possible to make wall profile measurements before the steel lining 88 is inserted into the borehole 87.

1. A method of producing a gravitational survey of a region comprising the steps of:
a) recording a plurality of gravitational measurements from a region in known locations;
b) obtaining information on the locations of any surface relief in the region likely to have an influence on the gravitational measurements, and estimating the density thereof;
c) using any information from step (b) to adjust the gravitational measurements to remove the effects thereon caused by the surface relief;
d) estimating a topological distribution of underground mass in the region;
characterised in that it includes the additional steps of
e) measuring a three dimensional (3D) representation of additional elements of the region likely to influence the gravitational measurements, and processing the 3D representation to estimate position and shape characteristics of the additional elements;
f) estimating a mass or masses of the additional elements of the region from the 3D representation;
g) providing estimated mass(es) calculated in step (f) along with their position and shape information from step (e), to initialise the estimation procedure of step (d).

2. A method as claimed in claim 1 wherein the step of estimating a topological distribution of underground masses uses a forward-model fitting algorithm.

3. A method as claimed in claim 1 wherein the step of estimating a topological distribution of underground masses uses an inversion algorithm.

4. A method as claimed in claim 1 wherein the additional elements likely to influence the gravitational measurements are man-made elements.

5. A method as claimed in claim 1 wherein the additional elements likely to influence the gravitational measurements comprise a wall of a borehole or underground conduit.

6. A method as claimed in claim 1 wherein the step of measuring the 3D representation of additional elements itself comprises the steps of:
i) making a representation comprising a succession of images at different locations of the region using a camera;
ii) processing the succession of images to extract element features;
iii) tracking the element features between successive image frames; and
iv) calculating a position, relative to the camera position, of the extracted features.

7. A method as claimed in claim 1′ wherein the step of measuring the 3D representation of additional elements is done using a lidar system.

8. A method as claimed in claim 1 wherein the step of measuring the 3D representation of additional elements is done using a sonic or ultrasonic measurement system.

9. A system for producing a gravitational survey, the system comprising:
a) a data recorder for recording data pertaining to surface structures in a region;
b) a gravitational field sensor for measuring gravitational field characteristics at a plurality of points in the region;
c) a computer comprising a processor and memory, and containing instructions enabling the computer to:
i) receive surface structures recordings and gravitational field measurements made by the surface relief data recorder and the gravitational field sensor, and any terrain information likely to influence the gravitational field measurements;
ii) calculate three dimensional positional information of elements from the surface structure measurements;
iii) estimate a mass or masses of the surface structures;
iv) estimate position, size and shape of sub-surface elements;
v) calculate an improved estimate of the position, size and shape of sub-surface elements from the received gravitational field measurements and the estimated masses and any other received terrain information, using one of an inversion algorithm and a forward-model fitting algorithm.

10. A system as claimed in claim 9 wherein the data recorder for recording surface structures comprises a camera adapted to take a succession of images of the surface structures from different positions, and a computer system adapted to receive the plurality of images and to process the succession of images to extract element features, to track the element features between successive image frames; and to calculate a position, relative to the camera position, of the extracted features.
